(19) United States
(12) Patent Application Publication
(10) Pub. No.: US 2016/0149894 A1
(43) Pub. Date: May 26, 2016

(54) SYSTEM AND METHOD FOR PROVIDING MULTI FACTOR AUTHENTICATION

(71) Applicant: Appright, Inc., Monarch Beach, CA (US)

(72) Inventors: Amer Jneid, Laguna Niguel, CA (US); Priyakumar Shakti Prasad, Noida (IN)

(21) Appl. No.: 14/948,124

(22) Filed: Nov. 20, 2015

Related U.S. Application Data
(60) Provisional application No. 62/084,103, filed on Nov. 25, 2014.

(51) Int. Cl. H04L 29/06

(52) U.S. Cl. CPC H04L 63/083; H04L 63/102; H04L 63/107

(57) ABSTRACT

An authentication technique is disclosed that permits or denies access to content based on several factors. Such factors include a user ID, a user password, a device ID, and a unique dynamic password. The unique dynamic password is only valid for a particular request to access the content. The unique dynamic password may be based on a key shared between a user device of a user desiring access to the content and an authentication server that permits or denies access to the content based on the authentication factors. The authentication factors may include whether a current geolocation of the user device meets a defined permissible geolocation specified in a user authentication profile. The authentication technique may further include obtaining approval to access the content by an administrative user. Additionally, the access to the content may be restricted based on duration, content, or termination by administrative user.

### CROSS REFERENCE TO RELATED APPLICATION

This application claims the benefit of the filing date of U.S. Provisional Patent Application, Ser. No. 62/084,103, filed on Nov. 25, 2014, entitled “System and Method for Providing Multi Factor Authentication,” which is incorporated herein by reference.

### FIELD

This disclosure relates generally to user authentication for providing secured access to data and/or applications, and in particular, to a system and method that uses a multi factor authentication procedure to authenticate a user for secured access to content, such as data and/or applications.

### BACKGROUND

Vast majority of corporations use ‘One Factor Authentication’ such as user identification (User ID) and Password to access their corporate network. Some network authentication grants access to network resources, including sensitive applications. There is a general belief that if the corporate network is secure, then all applications within the network are secure. Therefore, additional authentication for sensitive applications is generally not robust.

‘One Factor Authentication’ is based on static knowledge passwords that can be guessed, stolen, found by brute-force, or found by social engineering (e.g., phishing). A network with ‘One Factor Authentication’ can be easily compromised from within and is at much higher risk when connected to the Internet. Notably, vast majority of Clouds (Websites) use ‘One Factor Authentication’ to access the site data.

The ‘Two Factor Authentication’ is considered more secure. It is based on User ID and Password as a first authentication factor and a secret question or a One-Time Password as a second authentication factor. A secret question is typically a question a user selects that is personal to the user, such as the user's mother's maiden name, name of favorite pet, city of birth, etc. A One-Time Password is a password that is valid for only for a single login session or transaction. For every login, the server and the client generate a synchronized new One-Time Password based on a shared secret key.

A two factor authentication with a secret question is vulnerable since both factors are static and subjected to guessing, phishing, etc.

The ‘Two Factor Authentication’ with One-Time Password typically requires a cumbersome expensive implementation and each user must carry a specialized hardware token that generates a synchronized new One-Time-Password per authentication. Though this method is considered secure it is not practical for public cloud based applications and it is inconvenient as the hardware token can be misplaced, lost or stolen. Thus, the user is unable to access his network until the hardware token is recovered or replaced.

Another authentication technique recently introduced is based on a One Time Password, which uses smartphones as an alternative to the specialized hardware token. However, it is not considered secure for many reasons. The most notable reasons are: 1) the corresponding shared secret key is stored as clear text on the mobile; if the key is compromised, the corresponding server is compromised as well. 2) The shared secret key may also be stored on a third-party server, giving the third-party potential access to private and sensitive data and/or applications that the shared secret key is intended to protect.

### SUMMARY

An aspect of the disclosure relates a server comprising a network interface and a processor configured to: receive a request to access content from a user device by way of the network interface, wherein the request includes a user ID, a user password, a device ID identifying the user device, and a unique dynamic password; access a user authentication profile associated with the user ID and the user password; generate an internal unique dynamic password based on a key in the user authentication profile; and permit access to the content by the user device in response to: determining that the received device ID matches with an internal device ID in the user authentication profile, and determining that the received unique dynamic password matches the internal unique dynamic password.

Another aspect of the disclosure relates a server comprising a network interface and a processor configured to: receive a request to access content from a user device by way of the network interface, wherein the request includes a user ID, a user password, a device ID identifying the user device, a unique dynamic password, and a geolocation of the user device; access a user authentication profile associated with the user ID and the user password; generate an internal unique dynamic password based on a key in the user authentication profile; and permit access to the content by the user device in response to: determining that the received device ID matches an internal device ID in the user authentication profile, determining that the received unique dynamic password matches the internal unique dynamic password, and determining that the received geolocation of the user device is compliant with a permissible geolocation for the user device in the user authentication profile.

Another aspect of the disclosure relates to a user device, comprising a network interface and a processor configured to: send a request to access content to a server by way of the network interface, wherein the request includes a user ID, a user password, a device ID identifying the user device, and a unique dynamic password; and receive notification from the server by way of the network interface, wherein the notification indicates whether the request to access the content is approved or denied.

Other aspects, advantages and novel features of the present disclosure will become apparent from the following detailed description when considered in conjunction with the accompanying drawings.

### BRIEF DESCRIPTION OF THE DRAWINGS

FIG. 1 illustrates a block diagram of an exemplary data communication system in accordance with an aspect of the disclosure.

FIG. 2 illustrates a block diagram of an exemplary server in accordance with another aspect of the disclosure.

FIG. 3 illustrates a block diagram of an exemplary user device in accordance with another aspect of the disclosure.

FIG. 4 illustrates a flow diagram of an exemplary method of setting up an authentication environment to control access to content in accordance with another aspect of the disclosure.

FIG. 5 illustrates a flow diagram of an exemplary method of authenticating a user for secured access to content in accordance with another aspect of the disclosure.

FIG. 6 illustrates a flow diagram of another exemplary method of authenticating a user for secured access to content in accordance with another aspect of the disclosure.

FIG. 7 illustrates a flow diagram of yet another exemplary method of authenticating a user for secured access to content in accordance with another aspect of the disclosure.

FIG. 8 illustrates a flow diagram of still another exemplary method of authenticating a user for secured access to content in accordance with another aspect of the disclosure.

FIG. 9 illustrates a functional block diagram of an exemplary server in accordance with another aspect of the disclosure.

### DETAILED DESCRIPTION OF THE EXEMPLARY EMBODIMENTS

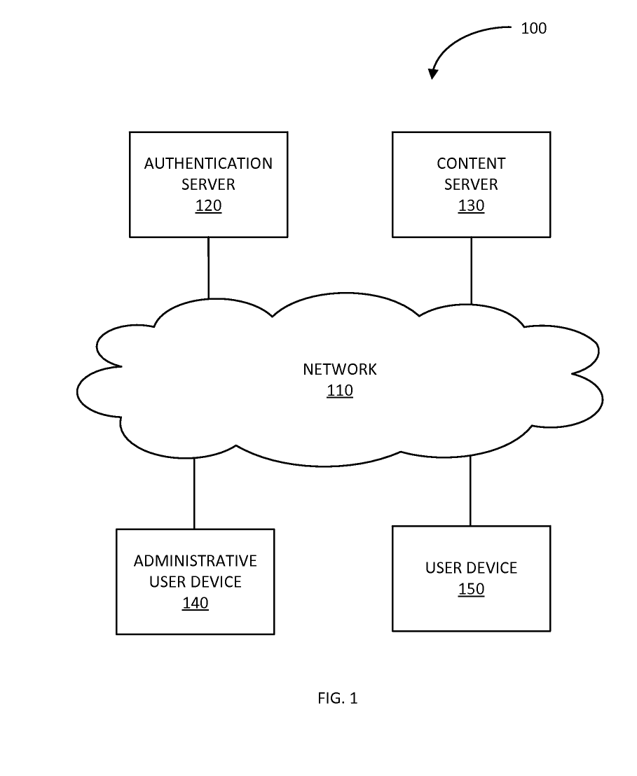

FIG. 1 illustrates a block diagram of an exemplary data communication system 100 in accordance with an aspect of the disclosure. The data communication system 100 includes an authentication server 120, a content server 130, an administrative user device 140, and a user device 150, all of which are coupled to a network 110. Although the authentication server 120 and the content server 130 are shown as separate servers, it shall be understood that the functionality of the authentication server 120 and the functionality of the content server 130 may be implemented on a single server.

The network 110 may be any network through which data is communicated between two or more servers and devices, such as the authentication server 120, the content server 130, the administrative user device 140, and the user device 150. Examples of the network 110 include a wide area network (WAN), such as the Internet, a local area network (LAN), a cellular telephone network, any combination of any one or more of the aforementioned, or other type of networks.

As discussed in more detail herein, the authentication server 120 is configured to set up an authentication environment for providing secured access to content offered by the content server 130 to authenticated users. The authentication server 120 also processes requests from users to access the content offered by the content server 130. The authentication environment includes user authentication profiles and applications to effectuate control of the access to the content by users.

The content server 130 provides content to authorized users that have been authenticated by the authenticated server 120 in accordance with several exemplary authentication procedures, as discussed further herein. The content offered by the content server 130 may include data, such as documents, audio files, pictures, videos, etc. Alternatively, or in addition to, the content offered by the content server 130 may include applications, such as word processing, spreadsheet, accounting, engineering, legal, graphics, and other types of applications. It shall be understood that the content may be solely data, solely application(s), and or both data and application(s). The content server 130 may be a private server (e.g., a company's internal server) or a public server (e.g., a server that provides content to authorized members of the public, such as subscribers).

As discussed in more detail herein, the administrative user device 140 is an example of a device used by an administrative user associated with the authentication environment set up by the authentication server 120. An administrative user using the device 140 may setup or assists in the setup of the authentication environment provided by the authentication server 120. Alternatively, or in addition to, an administrative user using the device 140 may assists in authenticating users requesting access to the content provided by the content server 130.

As discussed in more detail herein, the user device 150 is an example of a device used by a user desiring access to the content provided by the content server 130. A user using the device 150 performs an authentication procedure with the authentication server to setup the user and the user device 150 for authorized access to the content provided by the server 130. Additionally, a user using the device 150 performs an authentication procedure with the authentication server 120 to obtain (or not obtain, e.g., denied) authorization to access the content provided by the content server 130.

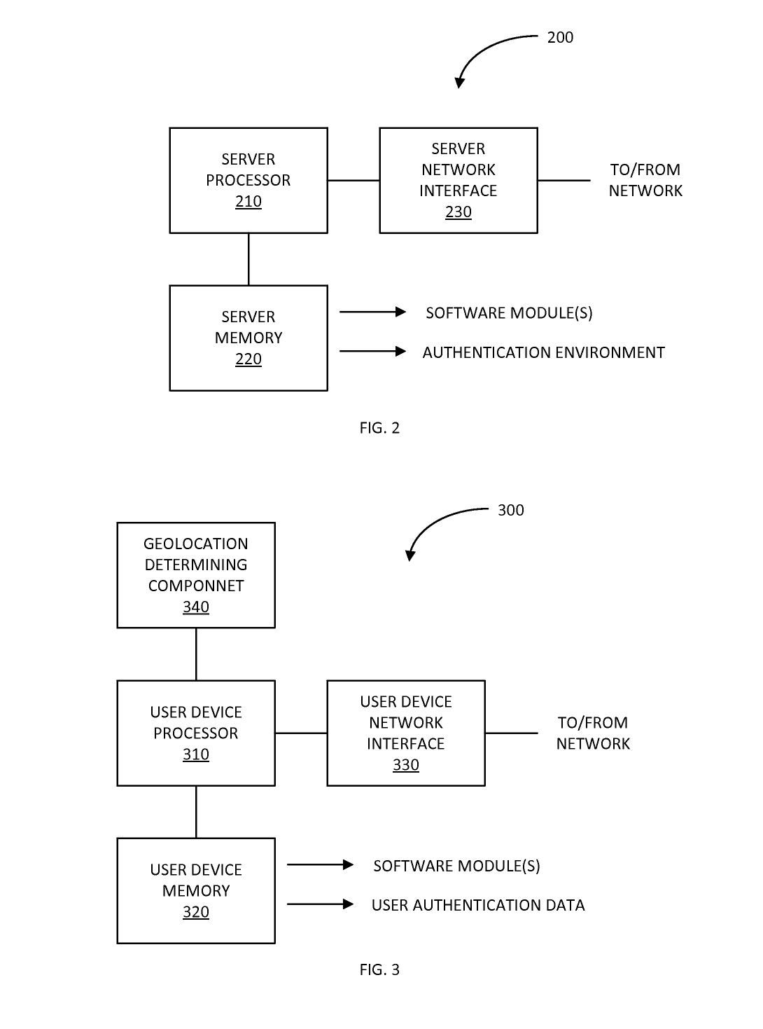

FIG. 2 illustrates a block diagram of an exemplary authentication server 200 in accordance with another aspect of the disclosure. The authentication server 200 may be an exemplary detailed implementation of the authentication server 120 previously discussed.

In particular, the authentication server 200 comprises a server processor 210, a server memory 220, and a server network interface 230. As discussed in more detail herein, the server processor 210 performs the various operations to setup an authentication environment for controlling authorized access to the content provided by the content server 130. Additionally, the server processor 210 performs the various operations to process requests from user devices to access the content provided by the content server 130. As an example, the server processor 210 may be any type of microprocessor.

The server memory 220 stores one or more software modules for controlling the operations of the server processor 210 previously discussed. Additionally, the server memory 220 stores information associated with the authentication environment, such as information used for authenticating users for access to the content provided by the content server 130. The server memory 220 may be any type of device for storing information, such as random access memory (RAM), non-volatile memory, solid-state drives (SSDs), hard magnetic disk drives, and others.

The server network interface 230 facilitates data communication between the server 200 and other devices on the network 110, such as the administrative user device 140, the user device 150, and the content server 130. The server network interface 230 may facilitate wired data communications, wireless data communications, or both wired and wireless data communications.

FIG. 3 illustrates a block diagram of an exemplary user device 300 in accordance with another aspect of the disclosure. The user device 300 may be an exemplary detailed implementation of the administrative user device 140, the user device 150, or both the administrative user device 140 and the user device 150. The administrative user device 140 and/or the user device 150 may be a computer (e.g., a desktop or laptop computer), smart phone, personal assistant device, or other type of device that may communicate data with the authentication server 120 via the network 110.

In particular, the user device 300 comprises a user device processor 310, a user device memory 320, a user device network interface 330, and a geolocation determining component 340. As discussed in more detail herein, in the case of an administrative user device, the user device processor 310 performs the various operations to assists the authentication server 120 in the setup of an authentication environment. Additionally, in the case of an administrative user device, the user device processor 310 performs the various operations to assists the authentication server 120 in the processing of requests from user devices for access to content provided by the content server 130. In the case of a user device, the user device processor 310 performs the various operations to get authenticated by the authenticated server 120 for secured access to the content provided by the content server 130. The user device processor 310 may be any type of microprocessor.

The user device memory 320 stores one or more software modules for controlling the operations of the user device processor 310 previously discussed. Additionally, the user device memory 320 stores user authentication information. The user device memory 320 may be any type of device for storing information, such as random access memory (RAM), non-volatile memory, solid-state drives (SSDs), hard magnetic disk drives, and others.

The user device network interface 330 facilitates data communication between the user device 300 and other devices on the network 110, such as the authentication server 120 and the content server 130. The user device network interface 330 may facilitate wired data communications, wireless data communications, or both wired and wireless data communications.

The geolocation determining component 340 determines the current geolocation of the user device for authentication purposes, as discussed in more detail below. The geolocation determining component 340 may be configured as a global positioning system (GPS) receiver, a cell tower triangulation component, or other types of location-determining component.

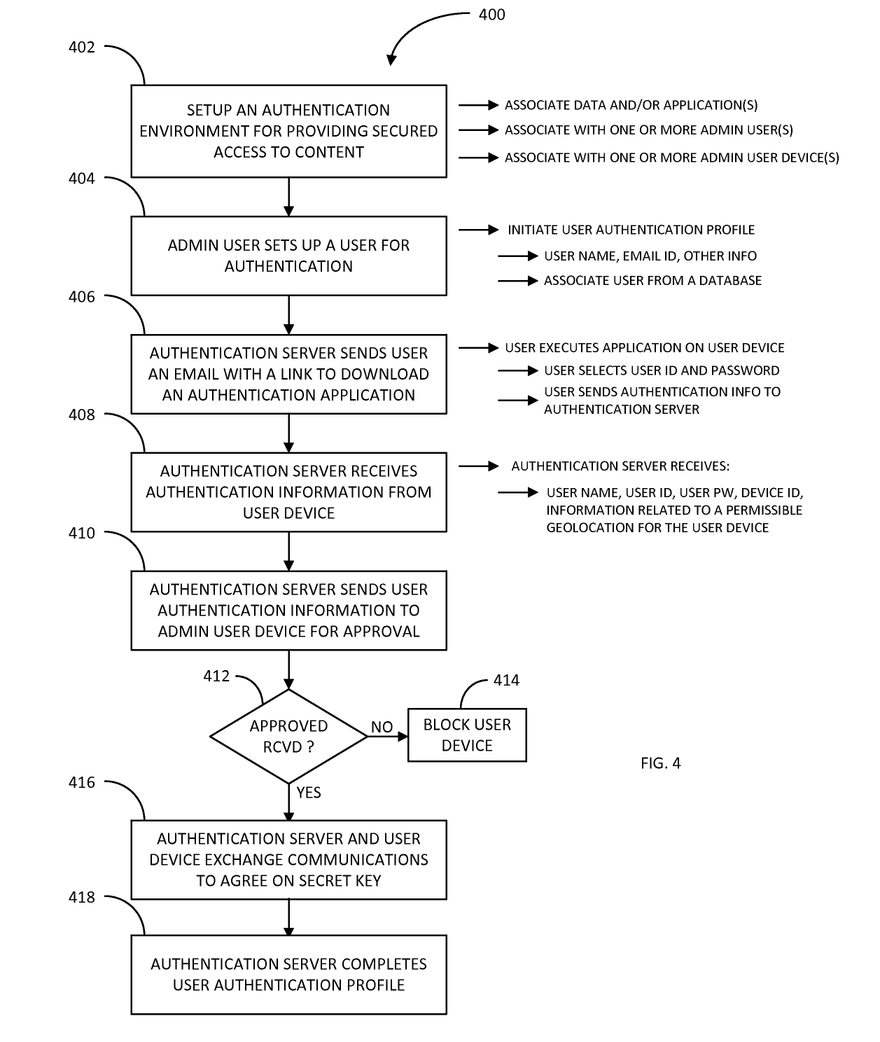

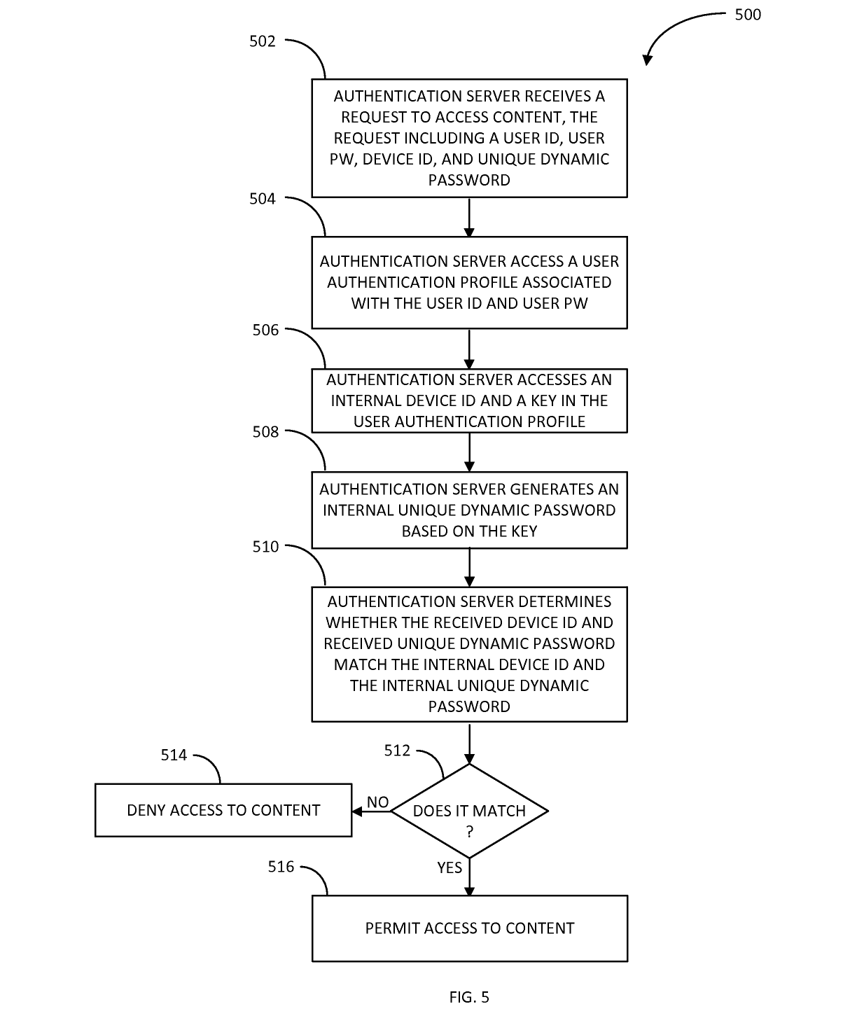

FIG. 4 illustrates a flow diagram of an exemplary method 400 of setting up an authentication environment for controlling secured access to content in accordance with another aspect of the disclosure.

According to the method 400, in response to a business request for setting up an authentication environment for providing secured access to content, an administrative user of the business using the administrative user device 140 sends such request to the authentication server 120 via the network 110 (block 402). The request may comprise associating the content (or storage area for the content) with the authentication environment. The request may further comprise associating one or more administrative users with the authentication environment, which could include the user of administrative user device 140. Additionally, the request may comprise associating one or more administrative user devices with the authentication environment, which could include the administrative user device 140.

As discussed in more detail below, one of the factors used to determine access to the authentication environment or access to the content is an identifier of the user device (device ID) attempting to access the authentication environment or the content. In other words, if the user is not using an authorized user device associated with the user, as indicated by the device ID, access to the authentication environment or the content may be denied. As examples, a device ID may include hard-coded identifier for personal computers (PCs), smart phones, tablet device, etc.

Further, according to the method 400, the administrative user using the administrative user device 140 accesses website screens (e.g., HTML documents) provided by the authentication server 120 via the network 110 to add one or more users (initiate user authentication profile(s)) to the authentication environment so that the one or more users would be provided access to the content (block 404). In this regard, the administrative user using the administrative user device 140 provides the authentication server 120 with the name, email address, and other information (e.g., address, telephone number, employee number, etc.) of each of the one or more users. Alternatively, or in addition to, the administrative user using the administrative user device 140 provides the user information to the authentication server 120 by associating user information contained in a directory service, such as a Lightweight Directory Access Protocol (LDAP) container, with the authentication environment.

Further, according to the method 400, the authentication server 120 sends an email with a link to download an authentication application to each of the one or more users, such as the user of user device 150, via the network 110 (block 406). In this regard, the user of user device 150 runs the application, which prompts the user for a user identification (user ID) and a user password. As discussed in more detail below, the user ID and password are used as a first authentication factor for the user to obtain access to the content provided by the content server 130. In response to receiving the user ID and user password, the authentication application causes the user device 150 to send the user ID, user password, and device ID of the user device 150, and possibly information related to a permissible geolocation information for the user device 150 to the authentication server 120 via the network 110. The permissible geolocation information may be used by an administrative user to specify a defined geographical area within which the user device 150 must be present to obtain authorization to access the content (e.g., within the United States). If the user device 150 is outside of the permissible geolocation, access to the content may be denied or restricted. The sending of the authentication information to the authentication server 120 may be in connection with the user attempting to log into the authentication server 120 for authentication purposes.

Further, according to the method 400, the authentication server 120 receives the user ID, password, the device ID, and possibly the permissible geolocation information from the user device 150 via the network 110 (block 408). In this regard, the authentication server 120 associates the received information with the user authentication profile in the authentication environment. Alternatively, the authentication server 120 may receive the permissible geolocation for the user device 150 from the administrative user device 140 via the network 110.

Further, according to the method 400, the authentication server 120 sends an authentication approval requests including the user authentication information to the administrative user device 140 via the network 110 (block 410). As previously discussed, such information may include one or more of the following: the user's name, email address, other information (e.g., address, telephone number, employee number, etc.), the user ID, the user password, the device ID, and the permissible geolocation information.

Further, according to the method 400, based on the received information, the administrative user using the administrative user device 140 sends a message to the authentication server 120 via the network 110, wherein the message indicates an approval or a denial of the authentication request for the user (block 412). In lieu of the operations indicated in blocks 410 and 412, the administrative user may have already pre-approved the user. Accordingly, the authentication server 120 may simply access the information in the authentication environment to determine if the user has been pre-approved.

If the message received from the administrative user is a denial, the authentication server 120 does not authenticate the user for access to the content provided by the content server 130 (block 414). The authentication server 120 may send the user device 150 via the network 110 a notification of the authentication denial. If, on the other hand, the user has been pre-approved or the message received from the administrative user is an approval to authenticate the user for access to the content provided by the content server 130, the authentication server 120 and the user device 150 exchange communications via the network 110 to agree on a secret key for generating a unique dynamic password or token valid only for a particular request to access content (block 416). The unique dynamic password is valid for only a defined time period (e.g., 60 seconds or less).

Once the secret key has been determined, the authentication server 120 completes the user authentication profile (with all of the relevant information as previously discussed) to indicate that the corresponding user using that particular user device 150 (as indicated by the unique identifier of the device (device ID)) is authorized for access to the content provided by the content server 130 (block 418). The user authentication profile may include the user ID, user password, one or more device IDs, the shared key, and the permissible geolocation for the user device.

FIG. 5 illustrates a flow diagram of an exemplary method 500 of authenticating a user for secured access to content in accordance with another aspect of the disclosure. In the example associated with method 500, the user using the user device 150 desires to access content provided by the content server 130 via the network 110.

According to the method 500, the authentication server 120 receives a request to access content from the user using the user device 150 via the network 110, wherein the request includes authentication information associated with the user (block 502). The authentication information includes the user ID, the user password, the device ID of the user device 150, and the unique dynamic password (e.g., the one-time session password or token). As previously discussed, the unique dynamic password may have been derived from a secret key shared by both the user device 150 and the authentication server 120. Although the unique dynamic password is based on the secret key, which may be static, the unique dynamic password changes each time an algorithm using the secret key is executed.

Further, according to the method 500, the authentication server 120 accesses a user authentication profile associated with the user ID and user password (block 504). Additionally, according to the method 500, the authentication server 120 accesses one or more internal device IDs and a key in the user authentication profile (block 506). Further, according to the method 500, the authentication server 120 generates an internal unique dynamic password based on the key (block 508).

Additionally, in accordance with the method 500, the authentication server 120 determines whether the device ID and the unique dynamic password received from the user device 150 match one of the internal device ID(s) and the internal unique dynamic password, respectively (block 510). Further, according to the method 500, if the authentication server 120 determines that the received device ID and the received unique dynamic password do not respectively match one of the internal device ID(s) and the internal unique dynamic password in block 512, the authentication server 120 denies access to the content by the user (block 514). The authentication server 120 need not notify the user of the denial of access to the content.

If, on the other hand, the authentication server 120 determines that the received device ID and the received unique dynamic password do respectively match one of the internal device ID(s) and the internal unique dynamic password in block 512, the authentication server 120 permits the user to have access to the content provided by the content server 130 (block 516). In this regard, the authentication server 120 may send a notification of the approval to the user device 150 via the network 110. The approval indicates that there is a valid pairing of the approved user with the approved user device as indicated in the user authentication profile.

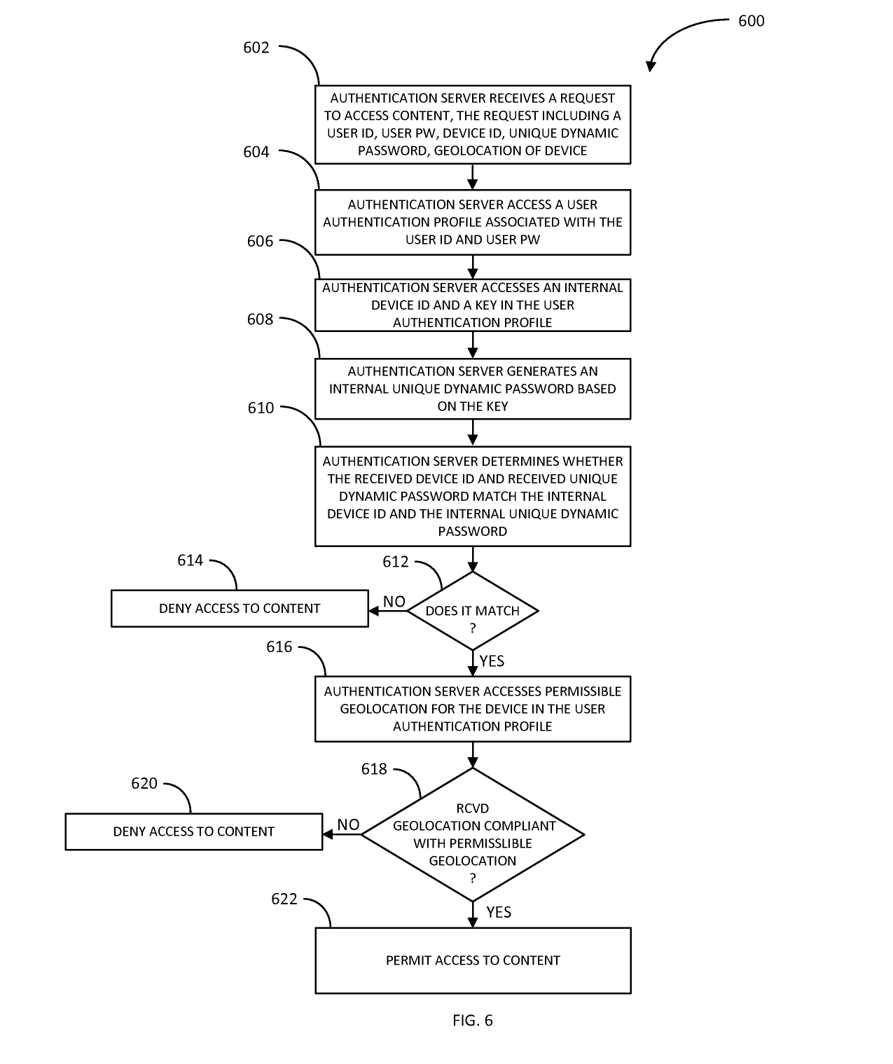

FIG. 6 illustrates a flow diagram of another exemplary method 600 of authenticating a user for secured access to content in accordance with another aspect of the disclosure. The method 600 is similar to that of method 500, but includes an additional factor for authentication; namely, the current geolocation of the user device 150. In method 400 of setting up the authentication environment, the administrative user using the administrative user device 140 may send information to the authentication server 120 via the network 110 to restrict the authenticated use of the user device 150 to a defined permissible geolocation.

For instance, if the user device 150 is outside of the defined permissible geolocation, the authentication server 120 denies access to the content, even though the other information (e.g., user ID, user password, device ID, and unique dynamic password) matches the information in the corresponding user authentication profile. However, if the user device 150 is within the defined permissible geolocation, and the other authentication information matches the information in the corresponding user authentication profile, the authentication server 120 permits access to the content.

According to the method 600, the authentication server 120 receives a request to access content from the user using the user device 150 via the network 110, wherein the request includes authentication information associated with the user (block 602). The authentication information includes the user ID, the user password, the device ID of the user device 150, the unique dynamic password (e.g., the one-time session password or token), and the current geolocation of the user device 150. As previously discussed, the unique dynamic password may have been derived from a secret key shared by both the user device 150 and the authentication server 120. Although the unique dynamic password is based on the secret key, which may be static, the unique dynamic password changes each time an algorithm using the secret key is executed.

Further, according to the method 600, the authentication server 120 accesses a user authentication profile associated with the user ID and user password (block 604). Additionally, according to the method 600, the authentication server 120 accesses one or more internal device IDs and a key in the user authentication profile (block 606). Further, according to the method 600, the authentication server 120 generates an internal unique dynamic password based on the key (block 608).

Additionally, in accordance with the method 600, the authentication server 120 determines whether the device ID and the unique dynamic password received from the user device 150 match one of the internal device ID(s) and the internal unique dynamic password, respectively (block 610). Further, according to the method 600, if the authentication server 120 determines that the received device ID and the received unique dynamic password do not respectively match one of the internal device ID(s) and the internal unique dynamic password in block 612, the authentication server 120 denies access to the content by the user (block 614). The authentication server 120 need not notify the user of the denial of access to the content.

If, on the other hand, the authentication server 120 determines that the received device ID and the received unique dynamic password do respectively match one of the internal device ID(s) and the internal unique dynamic password in block 612, the authentication server 120 accesses the permissible geolocation for the user device 150 in the user authentication profile (block 616). The authentication server 120 then determines whether the received current geolocation of the user device 150 is compliant with the permissible geolocation (block 618). If the authentication server 120 determines that the received current geolocation of the user device 150 is not compliant with the permissible geolocation (e.g., the user is outside of a defined geographical area) in block 618, the authentication server 120 denies access to the content by the user (block 620). The authentication server 120 need not notify the user of the denial of access to the content.

If, on the other hand, the authentication server 120 determines that the received current geolocation of the user device 150 is compliant with the permissible geolocation (e.g., the user is within a defined geographical area) in block 618, the authentication server 120 permits the user to have access to the content provided by the content server 130 (block 622). In this regard, the authentication server 120 may send a notification of the approval to the user device 150 via the network 110.

The approval indicates that there is a valid pairing of the approved user with the approved user device as indicated in the user authentication profile, and the geolocation of the approved user device is within a permissible geolocation as indicated in the user authentication profile at the time the request to access the content is made.

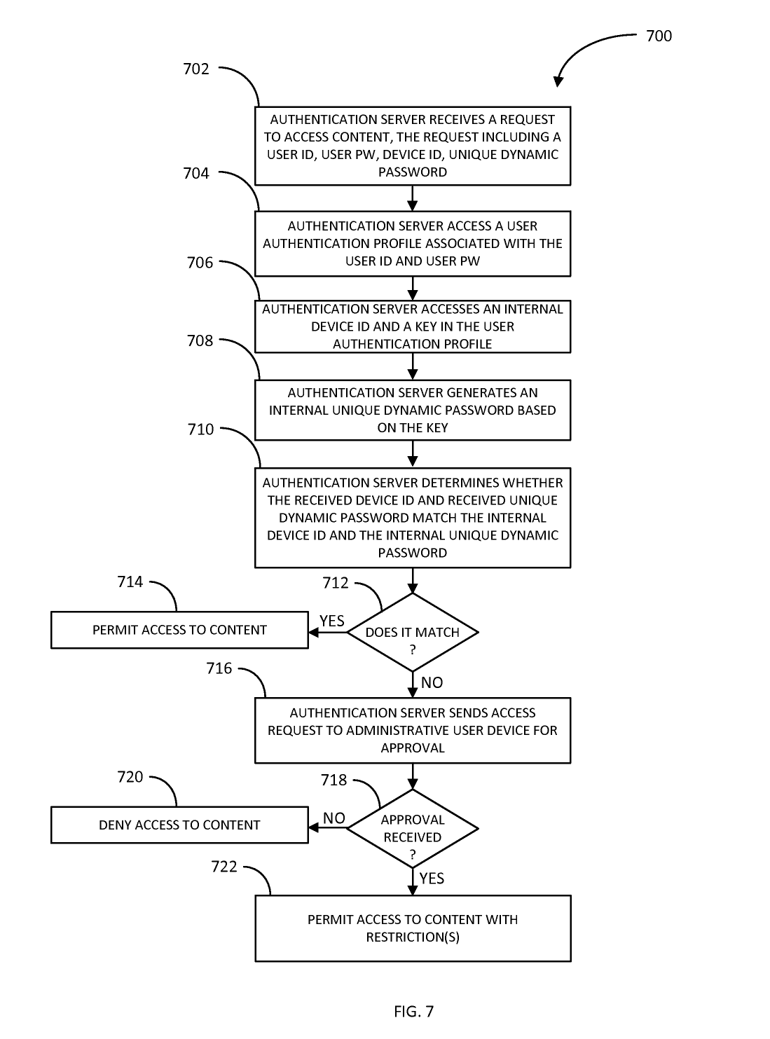

FIG. 7 illustrates a flow diagram of yet another exemplary method 700 of authenticating a user for secured access to content in accordance with another aspect of the disclosure. The method 700 is similar to that of method 500 previously discussed, except that method 700 takes into account verification of only a portion of the authentication information (e.g., the user ID and user password). With limitations as described below, restricted access to the content may be permitted if the user ID and user password are associated with a user authentication profile, but the received the device ID or received unique dynamic password does not match one of the internal device ID(s) or the internal unique dynamic password, respectively. This takes into account the scenario where an authorized user is using a device that is not identified in the user authentication profile.

According to the method 700, the authentication server 120 receives a request to access content from the user using the user device 150 via the network 110, wherein the request includes authentication information associated with the user (block 702). The authentication information includes the user ID, the user password, the device ID of the user device 150, and the unique dynamic password (e.g., the one-time session password or token). As previously discussed, the unique dynamic password may have been derived from a secret key shared by both the user device 150 and the authentication server 120. Although the unique dynamic password is based on the secret key, which may be static, the unique dynamic password changes each time an algorithm using the secret key is executed.

Further, according to the method 700, the authentication server 120 accesses a user authentication profile associated with the user ID and user password (block 704). Additionally, according to the method 700, the authentication server 120 accesses one or more internal device IDs and a key in the user authentication profile (block 706). Further, according to the method 700, the authentication server 120 generates an internal unique dynamic password based on the key (block 708).

Additionally, in accordance with the method 700, the authentication server 120 determines whether the device ID and the unique dynamic password received from the user device 150 match one of the internal device ID(s) and the internal unique dynamic password, respectively (block 710). Further, according to the method 700, if the authentication server 120 determines that the received device ID and the received unique dynamic password do respectively match one of the internal device ID(s) and the internal unique dynamic password in block 712, the authentication server 120 permits the user to have access to the content provided by the content server 130 (block 714). In this regard, the authentication server 120 may send a notification of the approval to the user device 150 via the network 110. The approval indicates that there is a valid pairing of the approved user with the approved user device as indicated in the user authentication profile.

If, on the other hand, the authentication server 120 determines that the received device ID and the received unique dynamic password do not respectively match one of the internal device ID(s) and the internal unique dynamic password in block 712, the authentication server 120 sends a request to approve the request to access the content to the administrative user device 140 via the network 110 (block 716). Then, the authentication server 120 determines whether an approval of the request sent in block 716 is received (block 718). If the authentication server 120 does not receive the approval in block 718, the authentication server 120 denies the request to access the content by the user (block 720). The authentication server 120 need not notify the user of the denial of access to the content.

If, on the other hand, the authentication server 120 receives the approval in block 718, the authentication server 120 permits restricted access to the content (block 722). For example, the restrictions may include: (1) permitting access to only a certain portion of the content (and denying access to other portion of the content); (2) permitting access to the content for only a defined duration (e.g., certain amount of hours) while using the user device identified by the received device ID; and/or (3) permitting access to the content until the administrative user terminates the access session. Thus, this covers the scenario where the approved user is using a different device (e.g., a device at a hotel, or a friend's device), and for security purpose, the administrative user permits a restricted access to the content.

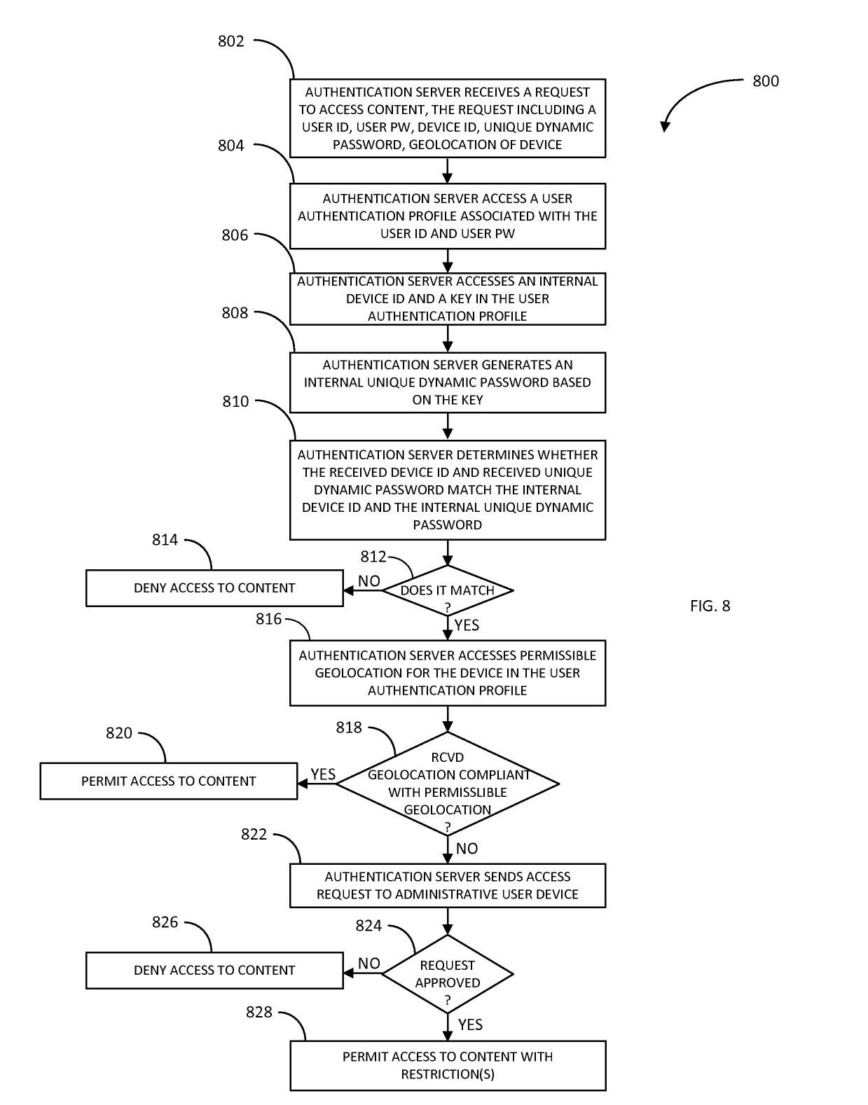

FIG. 8 illustrates a flow diagram of yet another exemplary method 800 of authenticating a user for secured access to content in accordance with another aspect of the disclosure. The method 800 is similar to that of method 700, but includes the additional authentication factor of the current geolocation of the user device 150. In method 800, restricted access to the content may be permitted by an administrative user if the user device is outside of the permissible geolocation for the user device. For example, this covers the scenario where the user has travelled outside of his/her home country and desires access to the content (e.g., the user is on a business trip), and the permissible geolocation for the user device is the user's home country.

According to the method 800, the authentication server 120 receives a request to access content from the user using the user device 150 via the network 110, wherein the request includes authentication information associated with the user (block 802). The authentication information includes the user ID, the user password, the device ID of the user device 150, the unique dynamic password (e.g., the one-time session password or token), and the current geolocation of the user device 150. As previously discussed, the unique dynamic password may have been derived from a secret key shared by both the user device 150 and the authentication server 120. Although the unique dynamic password is based on the secret key, which may be static, the unique dynamic password changes each time an algorithm using the secret key is executed.

Further, according to the method 800, the authentication server 120 accesses a user authentication profile associated with the user ID and user password (block 804). Additionally, according to the method 800, the authentication server 120 accesses one or more internal device IDs and a key in the user authentication profile (block 806). Further, according to the method 800, the authentication server 120 generates an internal unique dynamic password based on the key (block 808).

Additionally, in accordance with the method 800, the authentication server 120 determines whether the device ID and the unique dynamic password received from the user device 150 match one of the internal device ID(s) and the internal unique dynamic password, respectively (block 810). Further, according to the method 800, if the authentication server 120 determines that the received device ID and the received unique dynamic password do not respectively match one of the internal device ID(s) and the internal unique dynamic password in block 812, the authentication server 120 denies access to the content by the user (block 814). The authentication server 120 need not notify the user of the denial of access to the content.

If, on the other hand, the authentication server 120 determines that the received device ID and the received unique dynamic password do respectively match one of the internal device ID(s) and the internal unique dynamic password in block 812, the authentication server 120 accesses the permissible geolocation for the user device 150 in the user authentication profile (block 816). The authentication server 120 then determines whether the received current geolocation of the user device 150 is compliant with the permissible geolocation (block 818). If the authentication server 120 determines that the received current geolocation of the user device 150 is compliant with the permissible geolocation (e.g., the user is within a defined geographical area) in block 818, the authentication server 120 permits the user to have access to the content provided by the content server 130 (block 820). In this regard, the authentication server 120 may send a notification of the approval to the user device 150 via the network 110.

If, on the other hand, the authentication server 120 determines that the received current geolocation of the user device 150 is not compliant with the permissible geolocation (e.g., the user is outside of a defined geographical area) in block 818, the authentication server 120 sends a request to approve the request to access the content to the administrative user device 140 via the network 110 (block 822). Then, the authentication server 120 determines whether an approval of the request sent in block 822 is received (block 824). If the authentication server 120 does not receive the approval in block 824, the authentication server 120 denies the request to access the content by the user (block 826). The authentication server 120 need not notify the user of the denial of access to the content.

If, on the other hand, the authentication server 120 receives the approval in block 824, the authentication server 120 permits restricted access to the content (block 828). For example, the restrictions may include: (1) permitting access to only a certain portion of the content (and denying access to other portion of the content); (2) permitting access to the content for only a defined duration (e.g., certain amount of hours) while using the user device identified by the received device ID; and/or (3) permitting access to the content until the administrative user terminates the access session. Thus, this covers the scenario where the approved user is using the device outside of the permissible geolocation for the user device 150.

The restrictive or limited access may be based on the content. For instance, some content (data or application(s)) (that would otherwise be available if all the authentication information was verified) may not be available to the user because of the restrictive or limited access. Alternatively, or in addition to, the restrictive or limited access may be based on duration (e.g., a specified number of minutes, hours, days, etc.) and the user using the device identified by the received device ID. Alternatively, or in addition to, the restrictive or limited access may be based on the approval and termination by the administrative user. For example, the user's access to the content may begin when the authentication server 120 receives the approval per block 824. And, the user's access to the content may terminate in response the authentication server 120 receiving an access termination message from the administrative user device 140 via the network 110.

The nature of the restriction or limitation may be sent by the administrative user device 140 to the authentication server 120 via the network 110 at the time the approval was sent to the authentication server 120 per block 824. Alternatively, the user authentication profile may pre-include the nature of the access restriction or limitation. The authentication server 120 may also send a notification to the user device 150 via the network 110 regarding the parameters of the restricted access to the content.

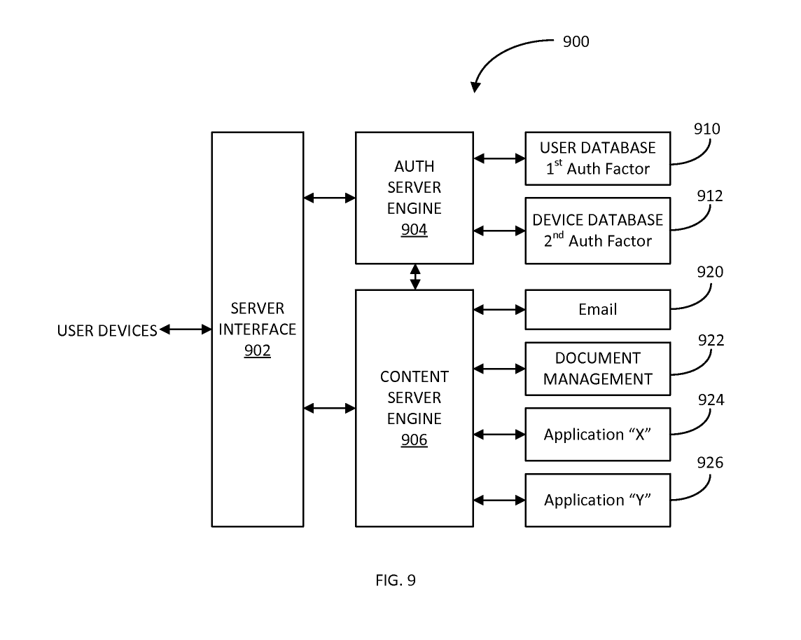

FIG. 9 illustrates a functional block diagram of an exemplary server 900 in accordance with another aspect of the disclosure. The server 900 is an example of a server that integrates an authentication server engine with a content server engine.

In particular, the server 900 comprises a server interface 902, an authentication server engine 904, and a content server engine 906. The server interface 902 receives requests to access the content from user devices, and provides authenticated user devices the requested content. The server interface 902 is coupled to the authentication server engine 904 and to the content server engine 906. The authentication server engine 904 is coupled to the content server engine 906.

For authentication purposes, the server 900 includes a user database 910 including user information (e.g., user IDs and user passwords) as a first authentication factor, and a device database 912 including approved device, shared keys, and permissible geolocation information as a second authentication factor. Although the databases 910 and 912 are shown separately, it shall be understood that the databases may be combined. The combined databases may be a virtual database that encompasses user authentication profiles, as previously discussed. The first and second databases 910 and 912 are coupled to the authentication server engine 904.

For content providing purposes, the server 900 further comprises application engines, such as an email engine 920, a document management engine 922, an application “X” engine 924, and an application “Y” engine 926. Although not shown, each of these application engines 920, 922, 924, and 926 may be coupled to associated databases containing data associated with email (e.g., emails), documents (e.g., text-based documents), data relevant to application “X”, and data relevant to application “Y”, respectively. The email engine 920, document management engine 922, application “X” engine 924, and application “Y” engine 926 are coupled to the content server engine 906.

In operation, when a user desires access to the content provided by the content server engine 906, a user, using a user device, sends a request to access the document to the server interface 902. The request may include the authentication information associated with the user, such as the user ID, user password, device ID, unique dynamic password, and optionally the geolocation of the user device. Using the user authentication information in the user and device databases 910 and 912, the authentication server engine 904 verifies the information. If the authentication server engine 904 does not verify the information, the authentication server engine 904 denies access to the content server engine 906.

If, on the other hand, the authentication server engine 904 verifies the information, the authentication server engine 904 sends a notification to the user via the server interface 904 approving the access request. The authentication server engine 904 further instructs the content server engine 906 to allow access to the various applications 920, 922, 924, and 926 and associated data by the user. Accordingly, once authenticated, the user sends requests to the content server engine 906 via the server interface 902 for accessing the various applications and associated data.

While the invention has been described in connection with various embodiments, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A server, comprising:
a network interface; and
a processor configured to:
receive a request to access content from a user device by way of the network interface, wherein the request includes a user ID, a user password, a device ID identifying the user device, and a unique dynamic password;
access a user authentication profile associated with the user ID and the user password;
generate an internal unique dynamic password based on a key in the user authentication profile; and
permit access to the content by the user device in response to:
determining that the received device ID matches an internal device ID in the user authentication profile; and
determining that the received unique dynamic password matches the internal unique dynamic password.

2. The server of claim 1, wherein the processor is configured to deny access to the content by the user device in response to the received device ID not matching the internal device ID.

3. The server of claim 1, wherein the processor is configured to deny access to the content by the user device in response to the received unique dynamic password not matching the internal unique dynamic password.

4. The server of claim 1, wherein the unique dynamic password is valid only for said request to access the content.

5. The server of claim 1, wherein the processor is configured to permit restricted access to the content in response to:
the received device ID not matching the internal device ID; or
the received unique dynamic password not matching the internal unique dynamic password; and
receiving a notification indicating an approval of the request to access the content from an administrative user device via the network server.

6. The server of claim 5, wherein the processor is configured to send a request for approval of the request to access the content to the administrative user via the network.

7. The server of claim 5, wherein the restricted access includes restricting access to the content by the user using the user device identified by the device ID to only within a defined time period.

8. The server of claim 5, wherein the restricted access includes restricting access to only certain portion of the content.

9. The server of claim 5, wherein the restricted access includes ending the access to the content in response to the processor receiving a termination of access notification from an administrative user device by way of the network interface.

10. The server of claim 1, wherein the processor is configured to create the user authentication profile based on a request to generate the user authentication profile received from an administrative user device by way of the network interface.

11. The server of claim 1, wherein the processor is configured to exchange communications with the user device to determine the key.

12. A server, comprising:
a network interface; and
a processor configured to:
receive a request to access content from a user device by way of the network interface, wherein the request includes a user ID, a user password, a device ID identifying the user device, a unique dynamic password, and a geolocation of the user device;
access a user authentication profile associated with the user ID and the user password;
generate an internal unique dynamic password based on a key in the user authentication profile; and
permit access to the content by the user device in response to:
determining that the received device ID matches an internal device ID in the user authentication profile;
determining that the received unique dynamic password matches the internal unique dynamic password; and
determining that the received geolocation of the user device is compliant with a permissible geolocation for the user device in the user authentication profile.

13. The server of claim 12, wherein the processor is configured to permit restricted access to the content in response to:
the received geolocation of the user device not being compliant with the permissible geolocation for the user device; and
receiving a notification indicating an approval of the request to access the content from an administrative user device via the network server.

14. The server of claim 13, wherein the restricted access includes restricting access to the content by the user using the user device identified by the device ID to only within a defined time period.

15. The server of claim 13, wherein the restricted access includes restricting access to only certain portion of the content.

16. The server of claim 13, wherein the restricted access includes ending the access to the content in response to the processor receiving a termination of access notification from an administrative user device by way of the network interface.

17. A user device, comprising:
a network interface; and
a processor configured to:
send a request to access content to a server by way of the network interface, wherein the request includes a user ID, a user password, a device ID identifying the user device, and a unique dynamic password; and
receive notification from the server by way of the network interface, wherein the notification indicates an approval of the request to access the content.

18. The user device of claim 17, further comprising a geolocation determining component configured to generate a current geolocation of the user device, wherein the request further comprises the current geolocation of the user device.

19. The user device of claim 17, wherein the processor is configured to generate the unique dynamic password based on a key that is shared with the server.

20. The user device of claim 17, wherein the notification indicates restricted access to the content, wherein the restricted access is based on a defined duration for access, wherein the restricted access is based on access to only a portion of the content, or wherein the restricted access is based on receiving a notice of termination of the access from the server.
